(19) United States
(12) Patent Application Publication
(10) Pub. No.: US 2019/0140894 A1
(43) Pub. Date: May 9, 2019

(54) SYSTEM AND METHOD FOR ENABLING HYBRID INTEGRATION PLATFORM THROUGH RUNTIME AUTO-SCALABLE DEPLOYMENT MODEL FOR VARYING INTEGRATION

(71) Applicant: Dell Products, LP, Round Rock, TX (US)

(72) Inventors: Manoj S. Gujarathi, Austin, TX (US); Jeffrey Plater, Havertown, PA (US); Brian J. Frantz, Glenside, PA (US); Jeffrey S. Burk, Chester Springs, PA (US)

(73) Assignee: Dell Products, LP, Round Rock, TX (US)

(21) Appl. No.: 15/802,919

(22) Filed: Nov. 3, 2017

(51) Int. Cl. H04L 12/24; H04L 29/08; H04L 29/06

(52) U.S. Cl. CPC H04L 41/0803; H04L 69/03; H04L 69/26; H04L 67/34

(57) ABSTRACT

An information handling system operating a cloud infrastructure management system may include a processor performing an exchange of electronic data records between an on-site customer data center and one or more public/private/hybrid cloud storage modules according to a specific integration process generated from a customized visual model with a plurality of visual modeling elements, identifying one or more cloud infrastructure requirements associated with the exchange, determine a cloud infrastructure configuration including one or more public/private/hybrid cloud storage modules meeting the identified one or more cloud infrastructure requirements, configure one or more public/private/hybrid cloud storage modules according to the determined cloud infrastructure configuration, and store each of the exchanged electronic data records within one of the public/private/hybrid cloud storage modules according to the determined cloud infrastructure configuration.

### FIELD OF THE DISCLOSURE

The present disclosure relates generally to a system and method for creating scalable infrastructure that can scale between an on-site customer data center and a public/private/hybrid cloud systems pursuant to an integration process modeled with a customer-designed visual flow diagram.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), a head-mounted display device, server (e.g., blade server or rack server), a network storage device, a network storage device, a switch router or other network communication device, other consumer electronic devices, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components, telecommunication, network communication, and video communication capabilities and require communication among a variety of data formats. Further, the information handling system may include cloud-based storage modules.

### BRIEF DESCRIPTION OF THE DRAWINGS

The present disclosure will now be described by way of example with reference to the following drawings in which:

FIG. 1 is a block diagram illustrating an information handling system according to an embodiment of the present disclosure;

FIG. 2 is a block diagram illustrating a simplified integration network in an embodiment according to the present disclosure;

FIG. 3 is a block diagram illustrating a user-generated flow diagram of an integration process according to an embodiment of the present disclosure;

FIG. 4 is a block diagram illustrating a cloud infrastructure management system according to an embodiment of the present disclosure;

FIG. 5 is a flow diagram illustrating a method of managing storage of electronic data records in one or more public/private/hybrid cloud storage modules according to an embodiment of the present disclosure; and

FIG. 6 is a flow diagram illustrating a method of reconfiguring storage of electronic data records within a public/private/hybrid cloud storage module according to an embodiment of the present disclosure.

The use of the same reference symbols in different drawings may indicate similar or identical items.

### DETAILED DESCRIPTION

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Conventional software development and distribution models have involved development of an executable software application, and distribution of a computer-readable medium, such as a CD-ROM, or distribution via download of the application from the worldwide web to an end user. Upon receipt of the computer-readable medium or downloaded application, the end user executes installation files stored on the CD-ROM to install the executable software application on the user's personal computer (PC), etc. When the software is initially executed on the user's PC, the application may be further configured/customized to recognize or accept input relating to aspects of the user's PC, network, etc., to provide a software application that is customized for a particular user's computing system. This simple, traditional approach has been used in a variety of contexts, with software for performing a broad range of different functionality. While this model might be satisfactory for individual end users, it is undesirable in sophisticated computing environments.

Today, most corporations or other enterprises have sophisticated computing systems that are used both for internal operations, and for communicating outside the enterprise's network. Much of present day information exchange is conducted electronically, via communications networks, both internally to the enterprise, and among enterprises. Accordingly, it is often desirable or necessary to exchange information/data between distinctly different computing systems, computer networks, software applications, etc. The enabling of communications between diverse systems/networks/applications in connection with the conducting of business processes is often referred to as “business process integration.” In the business process integration context, there is a significant need to communicate between different software applications/systems within a single computing network, e.g. between an enterprise's information warehouse management system and the same enterprise's SAP purchase order processing system. There is also a significant need to communicate between different software applications/systems within different computing networks, e.g. between a buyer's purchase order processing system, and a seller's invoicing system.

Relatively recently, systems have been established to enable exchange of data via the Internet, e.g. via web-based interfaces for business-to-business and business-to-consumer transactions. For example, a buyer may operate a PC to connect to a seller's website to provide manual data input to a web interface of the seller's computing system, or in higher volume environments, a buyer may use an executable software application known as EDI Software, or Business-to-Business Integration Software to connect to the seller's computing system and to deliver electronically a business “document,” such as a purchase order, without requiring human intervention to manually enter the data. Such software applications are readily available in the market today. These applications are typically purchased from software vendors and installed on a computerized system owned and maintained by the business, in this example the buyer. The seller will have a similar/complementary software application on its system, so that the information exchange may be completely automated in both directions. In contrast to the present disclosure, these applications are purchased, installed and operated on the user's local system. Thus, the user typically owns and maintains its own copy of the system, and configures the application locally to connect with its trading partners.

In both the traditional and more recent approaches, the executable software application is universal or “generic” as to all trading partners before it is received and installed within a specific enterprise's computing network. In other words, it is delivered to different users/systems in identical, generic form. The software application is then installed within a specific enterprise's computing network (which may include data centers, etc. physically located outside of an enterprises' physical boundaries). After the generic application is installed, it is then configured and customized for a specific trading partner after which it is ready for execution to exchange data between the specific trading partner and the enterprise. For example, Walmart® may provide on its website specifications of how electronic data such as Purchase Orders and Invoices must be formatted for electronic data communication with Walmart®, and how that data should be communicated with Walmart®. A supplier/enterprise is then responsible for finding a generic, commercially-available software product that will comply with these communication requirements and configuring it appropriately. Accordingly, the software application will not be customized for any specific supplier until after that supplier downloads the software application to its computing network and configures the software application for the specific supplier's computing network, etc. Alternatively, the supplier may engage computer programmers to create a customized software application to meet these requirements, which is often exceptionally time-consuming and expensive.

Recently, systems and software applications have been established to provide a system and method for on-demand creation of customized software applications in which the customization occurs outside of an enterprise's computing network. These software applications are customized for a specific enterprise before they arrive within the enterprise's computing network, and are delivered to the destination network in customized form. The Dell Boomi® Application is an example of one such software application. With Dell Boomi® and other similar applications, an employee within an enterprise can connect to a website using a specially configured graphical user interface to visually model an “integration process” via a flowcharting process, using only a web browser interface. During such a modeling process, the user would select from a predetermined set of process-representing visual elements that are stored on a remote server, such as the web server. By way of an example, the integration process could enable a bi-directional exchange of data between its internal applications, between its internal applications and its external trading partners, or between internal application and applications running external to the enterprise. Applications running external to the enterprise are commonly referred to as SaaS “Software as a Service.”

A customized data integration software application creation system in an embodiment may allow a user to create a customized data integration software application by modeling a data integration process flow using a visual user interface. A user may model the process flow by adding visual elements representing integration process components which are associated with codesets incorporating machine-readable, executable code instructions for execution by a run-time engine. Each process component may be associated with an integration process action to be taken on incoming data. Each process component may further be associated with process component parameters detailing specific aspects of the process action to be taken. For example, a process component may instruct the run-time engine to take the action of querying a database, and the process component parameters may provide the name, location, user name, and required password for achieving the action of querying the database. Each process component parameter in an embodiment may be associated with a data profile codeset.

If a process component having process component parameters specific to one of a user's known trading partners, the user may wish to reuse the same process component (which has already been tailored for use with a specific known trading partner) in other data integration process flows. In such a scenario, a user may save the process component already tailored for use with a specific known trading partner as a trading partner component, which the customized data integration software application creation system may associate with a trading partner codeset.

A customized data integration software in an embodiment may include a run-time engine for execution of one or more codesets, a connector codeset comprising data required for electronic communication in accordance with a specific application programming interface (API), a trading partner code set comprising data required for electronic communication with a specific trading partner's system, and/or a data profile codeset associated with a user-specified process component parameter. The dynamic runtime engine, when initiated, in an embodiment, may download all connector codesets, trading partner codesets, and data profile codesets associated with it, and execute those code instructions to perform the integration process modeled by the visual flowchart generated by the user.

As changes are made to this model, via the website, or to the code that executes the model, the executable software application may automatically check for and apply these changes as needed without requiring human intervention. Each visually modeled integration process may represent a complete end-to-end interface. For example, a process could be modeled to accept a purchase order (PO) from a retailer such as Walmart®, transform the PO into a format recognizable by a certain internal order management software application of the enterprise, and then insert the contents of that PO directly into the enterprise's order management system.

Recently, business owners have begun initiating long-term plans to migrate some business applications and data to the cloud, while continuing to enable other applications and data that must remain behind a secure firewall. Past solutions to this problem include storing a portion of proprietary electronic data records and applications in the public cloud while simultaneously storing the remaining portion of proprietary electronic data records on-site at the customer's location, behind a secure firewall (e.g. within an enterprise system). An issue exists with relation to the ability of businesses to store proprietary documents needing a secure firewall within the cloud.

Embodiments of the present disclosure address this issue by providing public/private/hybrid cloud storage modules and a cloud infrastructure management system within a hybrid integration platform. Public/private/hybrid cloud storage modules in embodiments may comprise one or more network servers providing storage capacity, maintained by an entity other than the owner of the proprietary documents. The hybrid integration platform of embodiments of the current application provides a platform through which electronic data records may be exchanged between on-site customer data centers, public cloud storage modules, and public/private/hybrid cloud storage modules, such that the integration process itself may be indifferent to the nature and location of the endpoint storage modules. Public/private/hybrid cloud storage modules in embodiments of the present disclosure may provide a cloud-based storage system, including firewall security for stored documents. By providing public/private/hybrid cloud storage modules complete with firewalls, embodiments of the present disclosure may allow data owners to vertically scale their data storage capabilities.

Integration and exchange of data between on-site customer data centers, public cloud, and public/private/hybrid cloud storage modules presents complex issues relating to the size and number of separate public/private/hybrid cloud storage modules needed to perform each integration or exchange. Public/private/hybrid cloud storage modules may have varying characteristics, making some public/private/hybrid cloud storage modules more appropriate for certain types and volumes of integrated data than others. However, the type and volume of the integrated data that will be exchanged in an integration process may not be known prior to execution of the integration process. For example, the volume of the data to be exchanged and whether the integration process will be executed in a continuous real-time scenario or in a burst extract, transform, load (ETL) scenario may not be known prior to execution (or repeated execution) of the integration process. If the volume of data integrated is unknown, too many or too few public/private/hybrid cloud storage modules may be dedicated to storage of the migrated data prior to execution of the integration process, causing inefficiencies or failures in storage to occur upon execution. Thus, an issue exists with respect to estimation of the volume of data records that will be exchanged or migrated between the public/private/hybrid cloud storage module and the on-site customer data center prior to execution of the integration process.

The cloud infrastructure management system in embodiments of the present disclosure address this issue by estimating the volume of data to be migrated or integrated prior to execution of the integration process. The cloud infrastructure management system in embodiments may make such an estimation based on analysis of several factors associated with the integration process visual flow model generated by the customer in the visual interface. For example, the cloud infrastructure management system in embodiments may estimate the volume of data records based on the number or type of branch elements, data process elements, process elements, connector elements, set properties elements, and map elements are used, depth of information contained within each set properties element, number of concurrent process elements that will be enacted, and/or analytics of previous executions of the modeled integration process. Upon estimation of the volume of data to be migrated during a given integration process prior to its execution, the cloud infrastructure management system in an embodiment may also dynamically dedicate public/private/hybrid cloud storage modules of varying sizes to the given integration process. Estimations of resources needed or volumes expected may be made from previous integrations conducted by the user preparing an integration process or crowdsourced from other users within a community of integrators utilizing the customized data integration software application creation system according to embodiments herein.

Issues also exist with respect to estimation of the amount of processing power and length of time such processing power will be dedicated to the integration process prior to its execution. If the integration process will be executed in a continuous real-time scenario, the hybrid integration platform may need to repeatedly access the public/private/hybrid cloud storage module and update the data stored therein based on repeated real-time executions of the same integration process. Such repeated access requires a system for tracking the location of each migrated data record within each public/private/hybrid cloud storage module. In contrast, if the integration process will be executed in a burst ETL format, the time at which the execution occurs may not be known ahead of time, but the integration process will likely involve a very large migration of data to or from the public/private/hybrid cloud storage module (stored up over a period of time) and will inhibit access of the public/private/hybrid cloud storage module by any other integration processes. Such an integration process may be suited for execution by a processor specifically dedicated solely to that process, since it involves a migration of a large volume of documents over a short period of time. In contrast, an integration process involving repeated real-time executions of small volumes of data may be better suited for execution by a processor that is not specifically dedicated to that process, since the migrations are individually small and happening repeatedly at unknown intervals. Thus, issues exist with respect to scalability of public/private/hybrid cloud storage module capacity, matching an integration process with an optimal processor configuration based on estimated processing requirements, and ability to adaptively move the data records within the public/private/hybrid cloud storage modules in response to high demands in throughput caused by burst ETL migrations.

The cloud infrastructure management system in embodiments of the present disclosure may address scalability issues by generating one or more private cloud storage nodes of varying sizes within each public/private/hybrid cloud storage module, allowing for horizontal scaling of the size of each public/private/hybrid cloud storage module. A node in embodiments may comprise some subset of storage capacity within each public/private/hybrid cloud storage module. For example, if a public/private/hybrid cloud storage module comprises a plurality of network servers, a node may comprise one of the plurality of network servers making up the public/private/hybrid cloud storage module. In such an example embodiment, each node (e.g. network server) may also have a preset processing capacity. The cloud infrastructure management system in embodiments may assign an integration process to one or more nodes based on the estimated volume of data to be migrated in the integration process, and on the estimated processing requirements for that integration process. The estimated volume of documents to be migrated and/or estimated processing requirements may be referred to herein as infrastructure requirements. The determination of the number of nodes and/or modules, as well as types of nodes and/or modules to assign to an integration process may be based on the estimated infrastructure requirements, and may be referred to herein as infrastructure management. Estimation of infrastructure requirements for an integration process may be made based upon data provided by previous integrations prepared with a customized data integration software application creation system including those crowdsourced from other users within a community of integrators or from previous integrations conducted by the user generating a presently analyzed integration. Further, aspects of the type of data required by connectors including caching and messaging data types, as well a heuristic monitoring of infrastructure requirements for integrations including data throughput, processing requirements, and memory requirements may be assessed for previous integrations and applied to estimate infrastructure requirements for an integration.

In addition, the cloud infrastructure management system may use an elastic file system operably connected to each node within a public/private/hybrid cloud storage module in order to track the location of each data record within the plurality of nodes within the public/private/hybrid cloud storage module. An elastic file system in embodiments may generate a plurality of folders, each file located within a single public/private/hybrid cloud storage module node, assign migrated data records to the generated folders, and track the location of each migrated data record within a given folder and node. The elasticity of the elastic file system in embodiments refers to the ability to automatically scale the storage capacity of each node, to reorganize the migrated data records, or to generate new folders as later data migrations occur, in order to optimize throughput of all data integration processes that may run concurrently to simultaneously migrate different data to or from the nodes within each public/private/hybrid cloud storage module. Use of such an elastic file system in embodiments allows for repeated access to data stored in each node of a public/private/hybrid cloud storage module associated with continuous real-time executions of an integration process.

The cloud infrastructure management system in embodiments of the present disclosure may provide for adaptive movement of data records within the public/private/hybrid cloud storage modules by operably connecting each node within a public/private/hybrid cloud storage module to an elastic load balancer that may relocate data records between nodes in response to estimated throughput demands. Each node of a public/private/hybrid cloud storage module may be simultaneously accessed by separate integration processes, and in some embodiments a single node may be accessed by one process at a time. In such embodiments, if two separate integration processes need to access the same node in order to complete an associated data migration, one of those integration processes must wait until the other integration process has completed, instead of running both integration processes simultaneously. The cloud infrastructure management system in embodiments of the present disclosure may adaptively respond to multiple integration processes attempting to access the same node within a public/private/hybrid cloud storage module by shifting the location of the portion of data the second integration processes is attempting to access to a separate node having free processing capacity, in order to allow both processes to execute simultaneously. Alternatively, the elastic load balancer in embodiments may continuously monitor the available storage within each node and balance the volume of data across all nodes in order to optimize the storage capacity of the public/private/hybrid cloud storage module. In such a way the cloud infrastructure management system in embodiments of the present disclosure may also address issues relating to ability to adaptively move the data records within the public/private/hybrid cloud storage modules in response to high demands in throughput caused by burst ETL migrations, or other causes during integration activity.

Examples are set forth below with respect to particular aspects of an information handling system for managing integration of electronic data records between an on-site customer data center and one or more public/private/hybrid cloud storage modules.

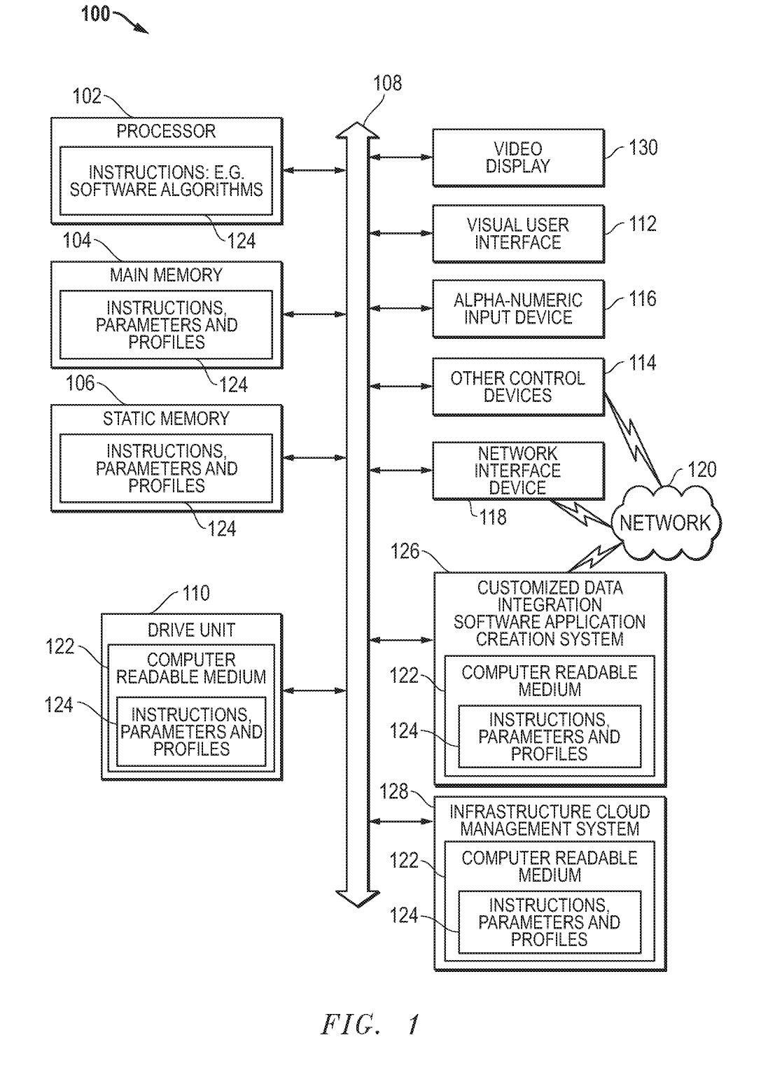

FIG. 1 is a block diagram illustrating an information handling system, according to an embodiment of the present disclosure. Information handling system 100 can include processing resources for executing machine-executable code, such as a central processing unit (CPU), a programmable logic array (PLA), an embedded device such as a System-on-a-Chip (SoC), or other control logic hardware used in an information handling system several examples of which are described herein. Information handling system 100 can also include one or more computer-readable media for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

FIG. 1 illustrates an information handling system 100 similar to information handling systems according to several aspects of the present disclosure. For example, an information handling system 100 may be any mobile or other computing device capable of executing a set of instructions (sequential or otherwise) that specify actions to be taken by that machine. In a particular embodiment, the information handling system 100 can be implemented using electronic devices that provide voice, video, or data communication. Further, while a single information handling system 100 is illustrated, the term “system” shall also be taken to include any collection of systems or sub-systems that individually or jointly execute a set, or multiple sets, of instructions to perform one or more computer functions.

Information handling system 100 can include devices or modules that embody one or more of the devices or execute instructions for the one or more systems and modules herein, and operates to perform one or more of the methods. The information handling system 100 may execute code 124 for customized data integration software application creation system, and/or code 128 for a cloud infrastructure management system that may operate on servers or systems, remote data centers, or on-box in individual client information handling systems such as a local display device, or a remote display device, according to various embodiments herein. In some embodiments, it is understood any or all portions of code 124 for a customized data integration software application creation system, and/or code 128 for a cloud infrastructure management system may operate on a plurality of information handling systems 100.

The information handling system 100 may include a processor 102 such as a central processing unit (CPU), a graphics processing unit (GPU), control logic or some combination of the same. Any of the processing resources may operate to execute code that is either firmware or software code. Moreover, the information handling system 100 can include memory such as main memory 104, static memory 106, drive unit 110, or the computer readable medium 122 of the customized data integration software application creation system 126 and/or cloud infrastructure management system 128 (volatile (e.g. random-access memory, etc.), nonvolatile (read-only memory, flash memory etc.) or any combination thereof). Additional components of the information handling system can include one or more storage devices such as static memory 106, drive unit 110, and the computer readable medium 122 of customized data integration software application creation system 126 and/or cloud infrastructure management system 128. The information handling system 100 can also include one or more buses 108 operable to transmit communications between the various hardware components such as any combination of various input and output (I/O) devices. Portions of an information handling system may themselves be considered information handling systems.

As shown, the information handling system 100 may further include a base video display unit 130, such as a liquid crystal display (LCD), an organic light emitting diode (OLED), a flat panel display, a solid state display, or other display device. Additionally, the information handling system 100 may include an alpha numeric control device 116, such as a keyboard, and another control device 114, such as a mouse, touchpad, fingerprint scanner, retinal scanner, face recognition device, voice recognition device, or gesture or touch screen input.

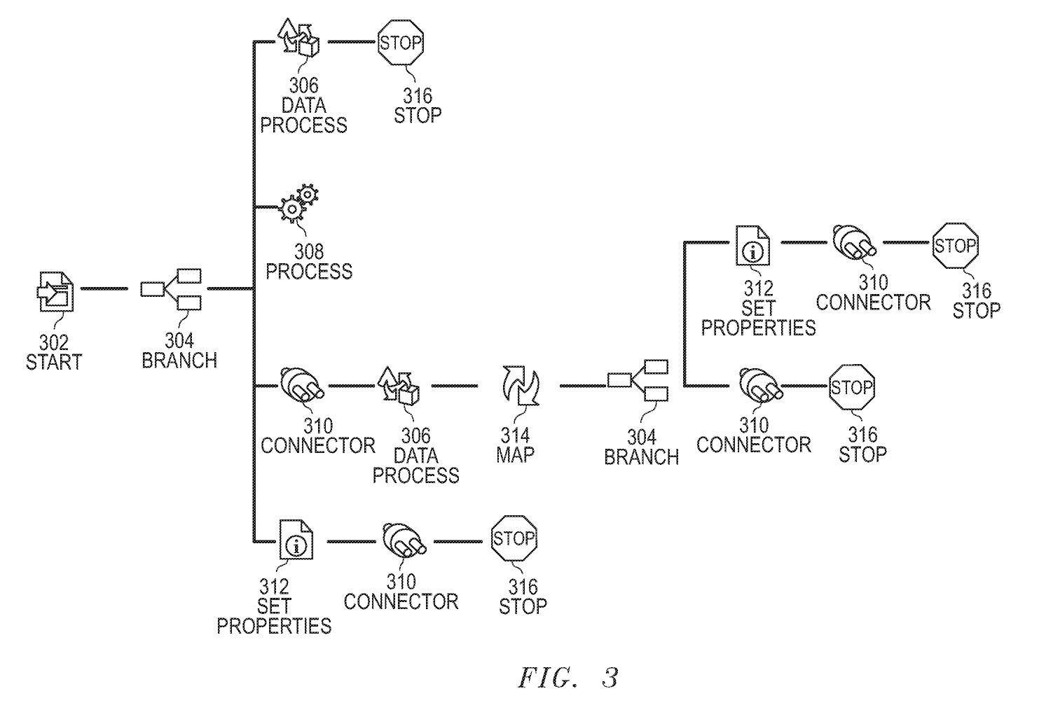

The information handling system 100 may further include a visual user interface 112. The visual user interface 112 in an embodiment may provide a visual designer environment permitting a user to define process flows between applications/systems, such as between trading partner and enterprise systems, and to model a customized business integration process. The visual user interface 112 in an embodiment may provide a menu of pre-defined user-selectable visual elements and permit the user to arrange them as appropriate to model a process, as described in greater detail below with reference to FIG. 3 and may be displayed on visual display 130. The elements may include visual, drag-and-drop icons representing specific units of work required as part of the integration process, such as invoking an application-specific connector, transforming data from one format to another, routing data down multiple paths of execution by examining the contents of the data, business logic validation of the data being processed, etc. Information and computer executable instructions for presenting such a graphical user interface 112 are stored in a memory of the customized data integration software application creation system 126.

Further, the graphical user interface 112 allows the user to provide user input providing information relating to trading partners, activities, enterprise applications, enterprise system attributes, and/or process attributes that are unique to a specific enterprise end-to-end business integration process. For example, the graphical user interface 112 may provide drop down or other user-selectable menu options for identifying trading partners, application connector and process attributes/parameters/settings, etc, and dialog boxes permitting textual entries by the user, such as to describe the format and layout of a particular data set to be sent or received, for example, a Purchase Order. The providing of this input by the user results in the system's receipt of such user-provided information as an integration process data profile codeset.

The information handling system 100 can represent a server device whose resources can be shared by multiple client devices, or it can represent an individual client device, such as a desktop personal computer, a laptop computer, a tablet computer, or a mobile phone. In a networked deployment, the information handling system 100 may operate in the capacity of a server or as a client user computer in a server-client user network environment, or as a peer computer system in a peer-to-peer (or distributed) network environment.

The information handling system 100 can include a set of instructions 124 and 128 that can be executed to cause the computer system to perform any one or more of the methods or computer based functions disclosed herein. For example, information handling system 100 includes one or more application programs 124 and 128, and Basic Input/Output System and Firmware (BIOS/FW) code 124. BIOS/FW code 124 functions to initialize information handling system 100 on power up, to launch an operating system, and to manage input and output interactions between the operating system and the other elements of information handling system 100. In a particular embodiment, BIOS/FW code 124 reside in memory 104, and include machine-executable code that is executed by processor 102 to perform various functions of information handling system 100. In another embodiment (not illustrated), application programs and BIOS/FW code reside in another storage medium of information handling system 100. For example, application programs and BIOS/FW code can reside in static memory 106, drive 110, in a ROM (not illustrated) associated with information handling system 100 or other memory. Other options include application programs and BIOS/FW code sourced from remote locations, for example via a hypervisor or other system, that may be associated with various devices of information handling system 100 partially in memory 104, storage system 106, drive unit 110 or in a storage system (not illustrated) associated with network interface device 112 or any combination thereof. Application programs 124 and 128, and BIOS/FW code 124 can each be implemented as single programs, or as separate programs carrying out the various features as described herein. Application program interfaces (APIs) such Win 32 API may enable application programs 124, and 128 to interact or integrate operations with one another.

In an example of the present disclosure, instructions 124 may execute customized data integration software application or software for creating the same, and the cloud infrastructure management system 128 as disclosed herein, and an API may enable interaction between the application program and device drivers and other aspects of the information handling system and software instructions 124 and 128 thereon. The computer system 100 may operate as a standalone device or may be connected, such as via a network, to other computer systems or peripheral devices.

Main memory 104 may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The disk drive unit 110, and the customized data integration software application creation system 126 may include a computer-readable medium 122 such as a magnetic disk in an example embodiment. The computer-readable medium of the memory, storage devices and customized data integration software application creation system 104, 106, 110, 126, and 128 may store one or more sets of instructions 124, such as software code corresponding to the present disclosure.

The disk drive unit 110, static memory 106, and computer readable medium 122 of the customized data integration software application creation system 126 and/or cloud infrastructure management system 128 also contains space for data storage such as an information handling system for managing storage of data records pursuant to execution of customized integration processes in public/private/hybrid cloud storage modules. Data including but not limited to a connector codeset, a trading partner codeset, a data profile codeset, and a run-time engine may also be stored in part or in full in the disk drive unit 110, static memory 106, or computer readable medium 122 of the customized data integration software application creation system 126 and/or cloud infrastructure management system 128. Further, the instructions 124 of the cloud infrastructure management system 128 may embody one or more of the methods or logic as described herein.

In a particular embodiment, the instructions, parameters, and profiles 124, and cloud infrastructure management system 128 may reside completely, or at least partially, within the main memory 104, the static memory 106, disk drive 110, and/or within the processor 102 during execution by the information handling system 100. Software applications may be stored in static memory 106, disk drive 110, the customized data integration software application creation system 126, and/or cloud infrastructure management system 128.

Network interface device 118 represents a NIC disposed within information handling system 100, on a main circuit board of the information handling system, integrated onto another component such as processor 102, in another suitable location, or a combination thereof. The network interface device 118 can include another information handling system, a data storage system, another network, a grid management system, another suitable resource, or a combination thereof.

The customized data integration application creation system 126 may also contain computer readable medium 122. While the computer-readable medium 122 is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The information handling system 100 may also include a cloud infrastructure management system 128, and the customized data integration software application creation system 126. Both the cloud infrastructure management system 128 and the customized data integration software application creation system 126 may be operably connected to the bus 108, and/or may connect to the bus indirectly through the network 120 and the network interface device 118. The cloud infrastructure management system 128 and the customized data integration software application creation system 126 are discussed in greater detail herein below.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a standalone device). The system, device, or module can include software, including firmware embedded at a device, such as a Intel® Core class processor, ARM® brand processors, Qualcomm® Snapdragon processors, or other processors and chipset, or other such device, or software capable of operating a relevant environment of the information handling system. The system, device or module can also include a combination of the foregoing examples of hardware or software. In an example embodiment, the customized data integration software application creation system 126, the cloud infrastructure management system 128 above and the several modules described in the present disclosure may be embodied as hardware, software, firmware or some combination of the same. Note that an information handling system can include an integrated circuit or a board-level product having portions thereof that can also be any combination of hardware and software. Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

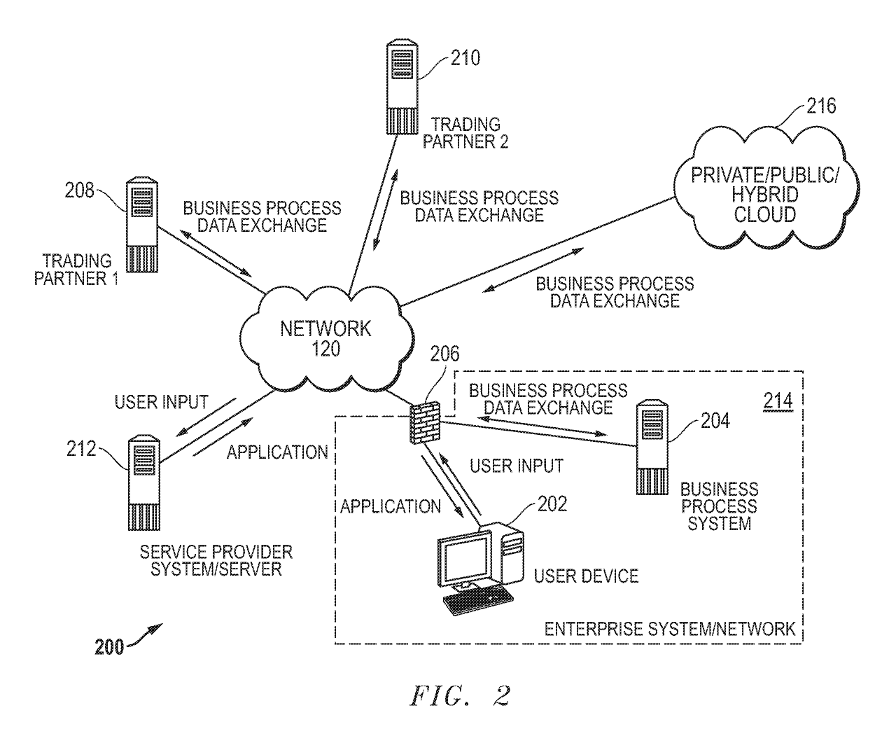

FIG. 2 is a block diagram illustrating a simplified integration network including an on-site customer data center and a public/private/hybrid cloud storage module in an embodiment according to the present disclosure. Actual integration network topology could be more complex in some other embodiments. As shown in FIG. 2, an embodiment may include conventional computing hardware of a type typically found in client/server computing environments. More specifically, the integration network 200 in an embodiment may include a conventional user/client device 202, such as a conventional desktop PC, enabling a user to communicate via the network 120, such as the Internet. In another aspect of an embodiment, the user device 202 may include a portable computing device, such as a computing tablet, or a smart phone. The user device 202 in an embodiment may be configured with conventional web browser software, such as Google Chrome®, Firefox®, or Microsoft Corporation's Internet Explorer® for interacting with websites via the network 120. In an embodiment, the user device 202 may be positioned within an enterprise network 214 behind the enterprise network's firewall 206, which may be of a conventional type. As a further aspect of an embodiment, the enterprise network 214 may include a business process system 204, which may include conventional computer hardware and commercially available business process software such as QuickBooks, Salesforce SAP's SAP ERP, Oracle's OneWorld JD Edward ERP, Infor's WMS Application, or many other types of databases.

In an embodiment, the integration network 200 may further include conventional hardware and software providing trading partners 208 and 210 for receiving and/or transmitting data relating to business-to-business transactions. It is contemplated such systems are conventional and well-known. For example, Walmart® may operate trading partner system 208 to allow for issuance of purchase orders to suppliers, such as the enterprise 214, and to receive invoices from suppliers, such as the enterprise 214, in electronic data form as part of electronic data exchange processes of a type well known, including, but not limited to via the world wide web, and via FTP or SFTP.

In an embodiment, a provider of a service (“service provider”) for creating on-demand, real-time creation of customized data integration software applications may operate a service provider server/system 212 within the integration network 200. The service provider system/server 212 may be specially configured in an embodiment, and may be capable of communicating with devices in the enterprise network 214. The service provider system/server 212 in an embodiment may be specially configured to store certain pre-defined, i.e. pre-built, datasets in its memory. Such data may include a pre-defined container (also referred to herein as a “dynamic runtime engine”) installation program that is executable at the enterprise system 214, or at a third party server (not shown) located remotely from both the service provider system/server 212 and the enterprise system 214.

The runtime engine may operate to download machine-readable, executable code instructions from the service provider server/system 212 in the form of codesets, which may include pre-built software code stored on the service provider system/server 212 such as connector codesets, trading partner codesets, and/or data profile codesets. The runtime engine may further operate to execute those codesets in order to perform an integration process, providing for exchange of business integration data between the enterprise's business process system 204 and user device 202 within the enterprise network 204, and/or between the enterprise network 214 and trading partners 208 and 210, and/or between the enterprise's internal computing system 204 and the enterprise's computing systems external to the enterprise network 214, commonly referred to as SaaS (Software as a Service). For example, the application template in an embodiment may be constructed as an integration of customer data between Salesforce.com and SAP using java programming technology.

A connector codeset in an embodiment may correspond to a modeled integration process component, but may not itself be configured for use with any particular enterprise, or any particular trading partner. Accordingly, the connector codeset may not yet be ready for execution to provide business integration functionality for any particular trading partner or enterprise until the connector codeset is configured to be executable with additional code and/or data in the form of one or more integration data profile codesets incorporating user-specific information or trading partner specific information. Thus, the connector codeset in an embodiment may be used by different enterprises or customers of the service provider 212. By configuring a connector codeset to be executable with a data profile codeset incorporating trading partner specific information, a user may instruct the creation of a trading partner codeset.

The dynamic runtime engine may download to its location pre-built connector codesets, trading partner codesets, and/or data profile codesets from the service provider system/server 212, and execute the pre-built connector codesets, trading partner codesets, and/or data profile codesets according to a visual flowchart residing at the service provider server/system 212 and modeled by the user using a provided visual graphical user interface as described in greater detail below.

The private/public/hybrid cloud 216 in an embodiment may also be connected to the network 120, and may transact business process data exchange with trading partner 1 208, trading partner 2 210, the service provider system/server 212, and on-site customer data centers within the enterprise system 214 via the network 120. In such a way, customers may migrate business applications and data to the cloud, while simultaneously keeping the business applications and data behind a secure firewall, if one is required.

FIG. 3 is a block diagram illustrating a user-generated flow diagram of an integration process for exchange of electronic data records between an on-site customer data center and a public/private/hybrid cloud storage module according to an embodiment of the present disclosure. A user may generate a flow diagram in an embodiment by providing a chronology of process-representing visual elements via the use of a visual user interface. As discussed above, the visual user interface in an embodiment may provide a visual designer environment permitting a user to define process flows between applications/systems, such as between trading partner and enterprise systems, and to model a customized business integration process. The visual user interface in an embodiment may provide a menu of pre-defined user-selectable visual elements and permit the user to arrange them as appropriate to model a process. The elements may include visual, drag-and-drop icons representing specific units of work (known as process components) required as part of the integration process, such as invoking an application-specific connector, transforming data from one format to another, routing data down multiple paths of execution by examining the contents of the data, business logic validation of the data being processed, etc. Information and computer executable instructions for presenting such a graphical user interface are stored in a memory of the customized data integration software application creation system in the form of connector codesets, trading partner codesets, and/or data profile codesets.

Each process component may be identifiable by a process component type, and may further include an action to be taken. For example, a process component may be identified as a “connector” component. Each “connector” component, when chosen and added to the process flow in the visual user interface, may provide a drop down menu of different actions the “connector” component may be capable of taking on the data as it enters that process step. The action the user chooses from the drop down menu may be associated with a process component action value, which also may be associated with a connector codeset. Further, the graphical user interface in an embodiment may allow the user to define the parameters of process components by providing user input, which the customized data integration software application creation system may correlate with a data profile codeset, also stored in a memory of the customized data integration software application creation system.

In an embodiment, a user may choose a process component it uses often when interfacing with a specific trade partner, and define the parameters of that process component by providing parameter values specific to that trading partner. If the user wishes to use this process component, tailored for use with that specific trading partner repeatedly, the user may save that tailored process component as a trading partner component, which will be associated with a trading partner codeset. For example, if the user often accesses the Walmart® purchase orders database, the user may create a database connector process component, associated with a pre-built connector codeset that may be used with any database, then tailor the database connector process component to access the specific purchase order database owned and operated by Walmart® by adding process component parameters associated with one or more data profile codesets. If the user uses this process component in several different integration processes, the user may wish to save this process component for later use by saving it as a trading partner component, which will be associated with a trading partner codeset. In the future, if the user wishes to use this component, the user may simply select the trading partner component, rather than repeating the process of tailoring a generic database connector process component with the specific parameters defined above.

The visual elements in an embodiment may indicate that the user wishes to perform a specific process upon a set of data, that specific process correlating to one or more connector codesets, trading partner codesets, and/or data profile codesets. Each of these codesets may be a pre-defined subset of code instructions stored at the system provider server/system in an XML format. The system provider server/system in an embodiment may generate a dynamic runtime engine for executing these pre-defined subsets of code instructions correlated to each individual process-representing visual element (process component) in a given flow chart in the order in which they are modeled in the given flow chart. The customized data integration software integration application in an embodiment is the set of code instructions represented by the process reflected in the flow chart created by the user (connector codesets or trading partner codesets), along with sets of code instructions correlating to received user input (data profile codesets), and along with the dynamic runtime engine that executes these sets of code instructions.

As shown in FIG. 3, such process-representing visual elements may include, but may not be limited to a start element 302, a branch element 304, a data process element 306, a process call element 308, a connector element 310, a set properties element 312, a map element 314, and a stop element 316. Although each of these process-representing visual elements may correspond to a connector codeset, they may not be configured for use with any particular enterprise or trading partner until further data attributes unique to the specific integration process are provided by the user in the form of user input associated with one or more integration process data profile codesets. Once the service provider server/system has received the user-generated flow diagram of the integration process and any necessary further user input in the form of data attributes unique to the specific integration process, the service provider server/system may generate a dynamic runtime engine, which is an executable software application capable of running on a computer within the enterprise's network available to the user of the website for download and installation within the enterprise network or at a third party server located remotely from both the service provider server/system and the enterprise network. When initiated, the dynamic runtime engine may connect to the service provider system/server, automatically download the XML connector codesets, trading partner codesets, and/or data profile codeset(s), and execute them according to the flowchart generated by the user to model the requested integration process.

In an embodiment, a start element 302 may operate to begin a process flow, and a stop element 316 may operate to end a process flow. As discussed above, each visual element may require user input in order for a particular enterprise or trading partner to use the resulting process. The start element 302 in an embodiment may further allow or require the user to provide data attributes unique to the user's specific integration process, including, but not limited to the source of incoming data to be integrated.

In an embodiment, a branch element 304 may operate to allow simultaneous processes to occur within a single dynamic runtime engine installation program. The branch element 304 in an embodiment may further allow or require the user to provide data attributes unique to the user's specific integration process, including, but not limited to the number of processes the user wishes to run simultaneously within a single dynamic runtime engine installation program.

In an embodiment, a data process element 306 may operate to manipulate document data within a process. The data process element 306 in an embodiment may further allow or require the user to provide data attributes unique to the user's specific integration process, including, but not limited to searching and replacing text, choosing to zip or unzip data, choosing to combine documents, choosing to split documents, or choosing to encode or decode data. For example, in an embodiment, a data process element may require the user to provide data attributes unique to the user's specific integration process, such as choosing a specific encryption type.

In an embodiment, a process element 308 may operate to execute another process from within a process (i.e. execute a subprocess). The process element 308 in an embodiment may further allow or require the user to provide data attributes unique to the user's specific integration process, including, but not limited to the name of the process the user wishes to become a subprocess of the process within the flow diagram.

In an embodiment, a connector element 310 may operate to enable communication with various applications or data sources between which the user wishes to exchange data. The connector element 310 in an embodiment may further allow or require the user to provide data attributes unique to the user's specific integration process, including, but not limited to the source of the data, and the operation the user wishes to perform on the data. For example, in an embodiment, the source of the data may be Salesforce.com, and the operation may include getting, sending, creating, deleting, updating, querying, filtering, or sorting of the data associated with a specific Salesforce.com account. For example, a connector element in an embodiment may require the user to provide data attributes unique to the user's specific integration process, such as choosing the name for the outbound file.

In an embodiment, a set properties element 312 may operate to set values for various document and process properties. The set properties element 312 in an embodiment may further allow or require the user to provide data attributes unique to the user's specific integration process, including, but not limited to a filename, or an email subject for the data being processed.

In an embodiment, a map element 314 may operate to transform data from one format to another or from one profile to another. The map element 314 in an embodiment may further allow or require the user to provide data attributes unique to the user's specific integration process, including, but not limited to the format to which the user wishes to transform the data.

The visual elements shown in FIG. 3 represent only a few examples of visual elements representing data integration processes, and it is contemplated the visual user interface may use other visual elements representing any type of data integration process that could be performed.

As described herein, the cloud infrastructure management system in an embodiment may reference the visual elements representing data integration processes, such as those shown in FIG. 3 to estimate the volume of data to be migrated or integrated prior to execution of the integration process, and to estimate the processing power required to complete the integration process. The cloud infrastructure management system in an embodiment may make such an estimation based on analysis of several factors associated with the integration process visual flow model generated by the customer in the visual interface. For example, the cloud infrastructure management system in embodiments may estimate the volume of data records and processing requirements based on the number or type of branch elements 304, data process elements 306, process elements 308, connector elements 310, set properties elements 312, and map elements 314 used, depth of information contained within each set properties 312 element, number of concurrent process elements 308 that will be enacted, and/or analytics of previous executions of the modeled integration process.

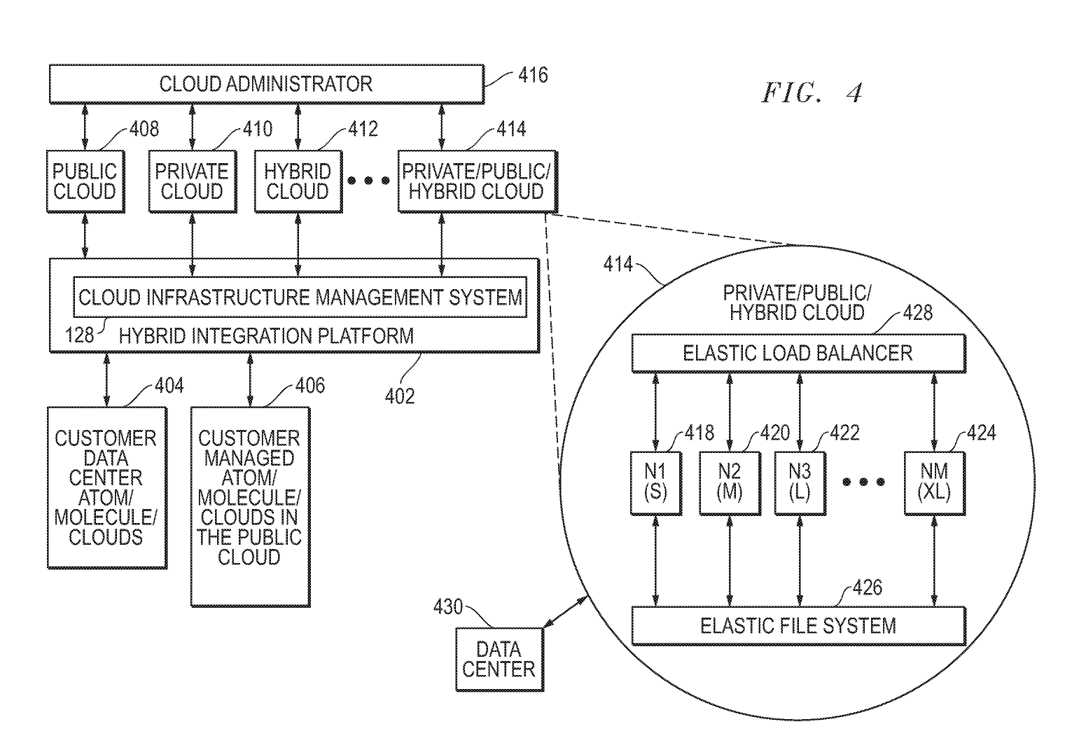

FIG. 4 is a block diagram illustrating a cloud infrastructure management system within a hybrid integration platform according to an embodiment of the present disclosure. As shown in FIG. 4, a hybrid integration platform 402 in an embodiment may be operably connected to a customer data center 404 and/or a customer managed public cloud storage module 406. For example, the customer data center 404 may include but may not be limited to an on-site customer data center located behind a security firewall, such as the enterprise network described herein with respect to FIG. 2. The hybrid integration platform 402 in an embodiment may operate within the service provider system/server described herein with respect to FIG. 2, or within the network described with respect to FIG. 2. As shown in FIG. 4, the hybrid integration platform 402 in an embodiment may be capable of receiving user input (e.g. a user-designed visual integration process flow diagram), transmitting a run-time engine and associated codesets to either the customer data center 404 or the customer managed public cloud storage module 406, and enabling business process data exchange between the customer data center 404, the customer managed public cloud 406, public cloud storage module 408, private cloud storage module 410, hybrid cloud storage module 412, and public/private/hybrid cloud storage module 414. Public/private/hybrid cloud storage modules 410-414 in an embodiment, may comprise, for example, one or more network servers providing storage capacity, maintained by an entity other than the owner of the proprietary documents. A public cloud storage module 408 may differ from a private cloud storage module 410 in that the private cloud storage module 410 may place all stored data behind a firewall, while public cloud storage module 408 may not. A hybrid cloud storage module 412 may store some stored data behind a firewall and some stored data not behind a firewall. The private/public/hybrid cloud storage module 414 in an embodiment may be comprised of a public cloud storage module, a private cloud storage module or a hybrid cloud storage module. Although FIG. 4 describes only four cloud storage modules 408-414, other embodiments may include any number of public/private/hybrid cloud storage modules.

By migrating data from an on-site customer data center e.g. 404 to one or more of the public/private/hybrid cloud storage modules 408-414 in an embodiment, customers may migrate business applications and data to the cloud, while simultaneously keeping the business applications and data behind a secure firewall, if one is needed. The hybrid integration platform of embodiments of the current application provides a platform through which electronic data records may be exchanged between on-site customer data centers e.g. 404, and public/private/hybrid cloud storage modules e.g. 408-414, such that the integration process itself may be indifferent to the nature and location of the endpoint storage modules. Public/private/hybrid cloud storage modules 408-414 in embodiments of the present disclosure may provide a cloud-based storage system, including firewall security for stored documents, if one is needed. By providing public/private/hybrid cloud storage modules complete with firewalls when necessary, embodiments of the present disclosure may allow data owners to vertically scale their data storage capabilities.

In previous systems, the outcome of an integration process involved migration of data records to a storage location other than a private/public/hybrid cloud managed by an entity other than customer (e.g. the on-site customer data center 404, or customer-managed public cloud storage module 406). In such systems, the customer managed the data center 404 or cloud storage modules 406 in which the migrated data would be stored, and presumably, had knowledge of the size and content of the migrated data, as well as processing requirements for each integration process, and/or an estimate of which processes would run simultaneously. As such, the customer could easily manage the data center 404 or cloud storage module 406 based on the known size and content of migrated data, and expected complexity and timing of future migrations. In embodiments of the present disclosure, where the migrated data may be stored in one or more public/private/hybrid cloud storage modules 414, customers need not know that information, nor are they required to manage the end location of the data migrated pursuant to a modeled integration process. In effect, each integration process modeled by a customer may be indifferent to the nature and location of the endpoint storage modules, removing the need for the customer to manage integration processes or storage of data migrated pursuant to integration processes.

Integration and exchange of data between on-site customer data centers e.g. 404, and public/private/hybrid cloud storage modules 414 presents complex issues relating to the size, number, and type of separate public/private/hybrid cloud storage modules 414 needed to perform each integration or exchange. Each public/private/hybrid cloud storage module 414 may have a different storage capability, number of nodes, and/or processing capacity. Integration processes involving larger volumes of data may require greater storage capacity and/or one or more processors that can be dedicate solely to that single process. More complex integration processes (e.g. involving more visual elements, a greater number of sources from which data will be fetched, or multiple sub processes) may require greater processing capabilities. In contrast, less complex integration processes, processes involving smaller volumes of data, and/or processes expected to be of short duration and executed infrequently or irregularly may require relatively less storage capacity and processing capabilities.

As described herein, in previous systems, the size and type of migrated data, as well as timing, complexity, and duration of integration process executions may have been known prior to each execution. In contrast, the type and volume of the integrated data that will be migrated to a private/public/hybrid cloud storage module 414 in an integration process, and timing and duration of executions of integration processes may not be known prior to execution of the integration process. For example, the volume of the data to be exchanged and whether the integration process will be executed in a continuous real-time scenario or in a burst extract, transform, load (ETL) scenario may not be known prior to execution (or repeated execution) of the integration process. As described directly above, public/private/hybrid cloud storage modules 414 may have varying characteristics, making some public/private/hybrid cloud storage modules 414 more appropriate for certain types of integrations and volumes of integrated data than others. If the volume of data integrated is unknown, too many or too few public/private/hybrid cloud storage modules 414 may be dedicated to storage of the migrated data prior to execution of the integration process, or too few processing resources may be dedicated to the integration process, causing inefficiencies or failures in migration, integration, and storage to occur upon execution.

The cloud infrastructure management system in an embodiment may reference the visual elements representing data integration processes, such as those shown in FIG. 3 to estimate the volume of data to be migrated or integrated, the complexity of the integration process, and the duration of the process prior to execution of the integration process. As described above, the complexity and duration of the process may assist in estimation of necessary processing capabilities. Upon estimation of the volume of data to be migrated during a given integration process, as well as the expected processing requirements and timing prior to its execution, the cloud infrastructure management system in an embodiment may also dynamically dedicate public/private/hybrid cloud storage modules of varying sizes and associated with varying processing resources to the given integration process.

Estimation of complexity of an integration process may be based upon its estimated infrastructure requirements. Infrastructure requirements of bandwidth, processing requirements and memory requirements for an integration process may be estimated based upon data provided by previous integrations prepared with a customized data integration software application creation system. Data of infrastructure requirements for previous processes are used to assess integration complexity including infrastructure data crowdsourced from other users within a community of integrators or from previous integrations conducted by the user generating a presently analyzed integration. Further, aspects of the type of data required by connectors including caching and messaging data types, as well a heuristic monitoring of infrastructure requirements for integrations including data throughput, processing requirements, and memory requirements may be assessed for previous integrations and applied to estimate infrastructure requirements for an integration.

For example, in an embodiment, the private cloud storage module 410 may have a smaller storage capacity than public/private/hybrid cloud storage module 414, and thus, the cloud infrastructure management system 128 may determine the private cloud storage module 410 is more appropriate for storage of data migrated pursuant to an integration process modeled by a less complex visual display having fewer elements, fewer set properties entries, or associated with historically smaller resultant migrations. As another example, in embodiments where the visual model of the integration process describing the future data migration is more complex or is associated with historically greater resultant migrations, the cloud infrastructure management system 128 may direct the resultant migrated data to the larger private cloud 414, to more than one private cloud (e.g. 412 and 414), or may create more public/private/hybrid cloud storage modules (not shown), in order to handle the projected capacity of the future data migration.

As yet another example, the private cloud storage module 410 may be associated with a less robust processor having fewer processing resources available than the processor associated with the public/private/hybrid cloud storage module 414. In such an embodiment, the cloud infrastructure management system 128 may determine an integration process expected to occur in a burst ETL format which likely will require large processing resources during execution may be better suited for the more robust processing power of the public/private/hybrid cloud storage module 414. In yet another example embodiment, the cloud infrastructure management system 128 may determine an integration process expected to occur in a real-time format, involving repeated short migrations of small volumes of data involving relatively smaller processing resources may be more suited to private cloud storage module 410, leaving the more robust processing resources of public/private/hybrid cloud storage module 414 available for more processor-heavy integrations.

Each public/private/hybrid cloud storage module in an embodiment may further comprise a plurality of storage nodes, an elastic file system, and an elastic load balancer, allowing for horizontal scaling within each public/private/hybrid cloud storage module. As shown in FIG. 4, for example, public/private/hybrid cloud storage module 414 may further include a first storage node 418, a second storage node 420, a third storage node 422, and several other storage nodes (not shown) up to storage node m 424. A node in embodiments may comprise some subset of storage capacity within each public/private/hybrid cloud storage module. For example, if a public/private/hybrid cloud storage module comprises a plurality of network servers, a node may comprise one of the plurality of network servers making up the public/private/hybrid cloud storage module.

Each storage node within a public/private/hybrid cloud storage module may have a different storage capacity and may be associated with a separate processor, each processor associated with a different capability. For example, the first storage node 418 may have a small (S) capacity, the second storage node 420 may have a medium (M) capacity, the third storage node 422 may have a large (L) capacity, and the m^{th} storage node 424 may have an extra large (XL) storage capacity. As another example, the first storage node 418 may be associated with a minimum processing capability, the second storage node 420 may be associated with a relatively greater processing capability than the first storage node 418, the third storage node 422 may be associated with a relatively greater processing capability than the first and second storage nodes 418 and 420, and the m^{th} storage node 424 may be associated with the greatest processing capability, relatively speaking.

In an embodiment, the number of storage nodes within each public/private/hybrid cloud storage module and size of each storage node may be controlled by the cloud infrastructure management system 128, and may be based on the projected volume of data expected to be migrated in a future execution of an integration process, the complexity of the process, the expected timing of multiple integration processes, and/or the expected duration of one or more integration processes as described herein. In other embodiments, the number of storage nodes within each public/private/hybrid cloud storage module, the size of each storage node, and the assignment of a given storage node to a given integration process may be based on attempts to optimize future throughput values, and/or to optimize the distribution of data stored across all nodes 418-424 within a public/private/hybrid cloud storage module, as described in greater detail below.

Throughput in embodiments may describe the volume of data being migrated or integrated pursuant to all executing integration processes at any given time, and/or the number of integration processes that may be simultaneously executed at any given time. Throughput may be optimized, in one example embodiment, by associating each integration process expected to be executed simultaneously with either separate public/private/hybrid cloud storage modules (e.g. 414), and/or with a single public/private/hybrid cloud storage module (e.g. 414) but with separate nodes (e.g. 418-424) within the single public/private/hybrid cloud storage module. Such a configuration may allow separate processors, each associated with a separate public/private/hybrid cloud storage module (e.g. 414), or associated with a separate node (e.g. 418-424), to run a separate integration process such that all integration processes may execute simultaneously and may each have dedicated processing resources to do so. This example configuration may be particularly optimal in embodiments in which multiple burst/ETL migrations involving large volumes of data are expected to occur simultaneously.

Throughput may be optimized, in another example embodiment, by associating multiple integration processes expected to occur at irregular intervals, over short periods of time, and/or involving small volumes of data with the same public/private/hybrid cloud storage module (e.g. 414), and/or with the same node (e.g. one of 418-424) within the single public/private/hybrid cloud storage module. Such a configuration may dedicate only a single processor to execution of these small migrations occurring at infrequent intervals, and the single processor dedicated may have relatively less processing power (e.g. may be slower) than other more robust processors. Further, because these small migrations are expected to each be of short duration, dedication of only a single, less-robust processor in such a scenario to several small migrations of short duration likely will not inhibit or unduly delay the execution of each of these processes, and will reserve processors having greater processing power for use in integration processes requiring greater processing resources, such as burst/ETL migrations.

In yet another example embodiment, throughput may be maximized by associating a single, complex integration process involving a large volume of data with multiple storage modules and/or multiple nodes. If such a complex integration process involves multiple sub processes, throughput may be optimized by dedicating a different node, each having a different processor, to each sub process. In such a scenario, the complexity and/or duration of each sub process, and/or the volume of data expected to be integrated in each sub process may be used to determine which node to dedicate to each sub process. If such a complex integration process does not involve execution of multiple sub processes, but involves a single integration process involving a large volume of documents, throughput may be optimized by simply dedicating a single node of large storage capacity to the integration process.

The elastic file system 426 in an embodiment may track the location (e.g. which of nodes 418-424) of each migrated data record within the public/private/hybrid cloud storage module 414. An elastic file system 426 in an embodiment may adaptively control the storage capacity of each node 418-424 by automatically scaling the storage capacity up or down as a data record is migrated in or out of the node. The cloud infrastructure management system 128 in an embodiment may be capable of accessing the elastic file system 426 in order to direct repeated accesses to a particular set of migrated data within the public/private/hybrid cloud storage module 414, as would occur in an often repeated integration process executed in a continuous real-time scenario. The elastic file system 426 in an embodiment may be any elastic file system known in the art.

The elastic load balancer 428 in an embodiment may analyze the volume and type of data stored in each of the storage nodes 418-424 within the private cloud 414 in order to perform operations to optimize future throughput values, or to optimize distribution of data stored across all nodes 418-424 within the public/private/hybrid cloud storage module 414, as described in greater detail below. In an embodiment, the elastic load balancer 428 may route incoming data migration traffic to specific nodes or public/private/hybrid cloud storage modules in order to optimize throughput of such data, and may direct the elastic file system 426 to auto scale the storage capacity of one or more storage nodes 418-424 to optimize throughput. The elastic load balancer 428 in an embodiment may be any elastic load balancer known in the art.

The data center 430 in an embodiment may be, for example, an on-site customer data center, or may operate within the service provider system/server, and may be connected to the public/private/hybrid cloud storage module 414 via a tunnel communication portal. If the data center 430 is an on-site customer data center, the on-site customer data center 430 may access the migrated data stored within the public/private/hybrid cloud storage module 414 directly via the tunnel communication portal when needed. If the data center 430 is operating within the service provider system/server, the service provider system server data center 430 may use the tunnel to access the migrated data intermittently in order to gather analytics regarding the volume and type of data migrated pursuant to each integration process modeled and maintained at the service provider system/server. Such analytics may be accessed at a later time by the cloud infrastructure management system 128 in order to determine the proper configuration (e.g. number and type of public/private/hybrid cloud storage modules or storage nodes) to associate with future migrations.

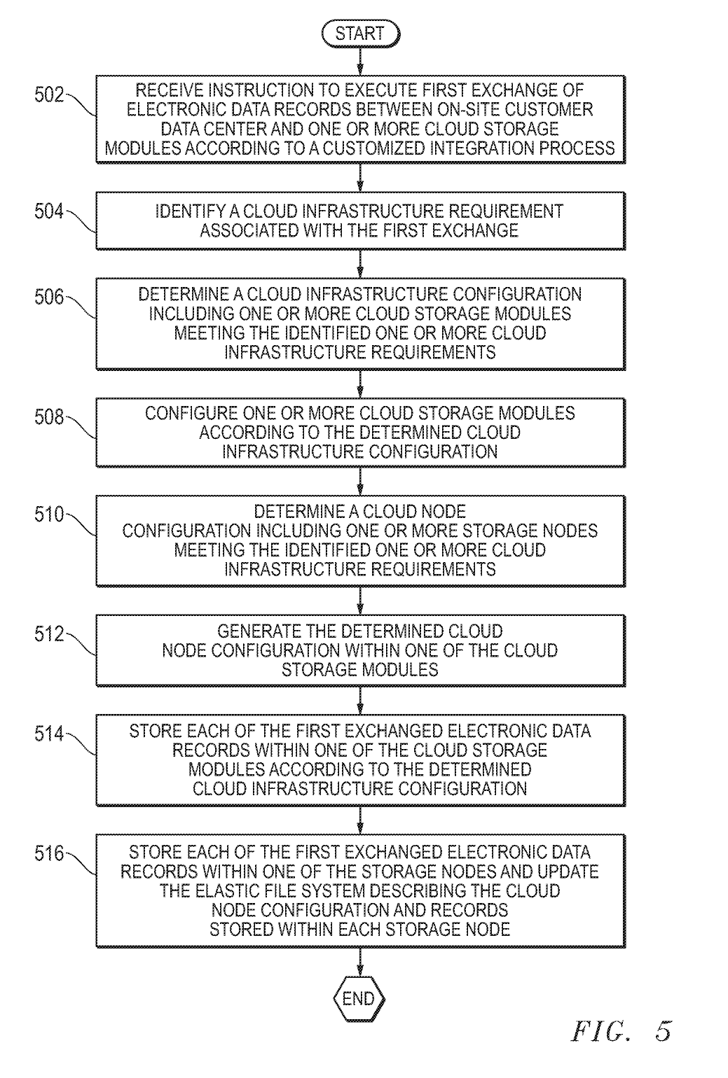

FIG. 5 is a flow diagram illustrating a method of managing storage of electronic data records exchanged in a customized integration process in one or more public/private/hybrid cloud storage modules according to an embodiment of the present disclosure. The method of FIG. 5 in an embodiment may address issues associated with not knowing the size and type of data to be migrated in each integration process, or the processing requirements needed to execute such an integration process. In previous systems, the size and content of the migrated data associated with each integration process, as well as the processing requirements for each integration process may have been known prior to execution of any of the integration processes. In contrast, the type and volume of the integrated data that will be migrated to a public cloud storage module in an integration process, and/or the processing requirements for execution of the process may not be known prior to execution of the integration process. If the volume of data integrated or processing requirements is unknown, too many or too few public/private/hybrid cloud storage modules, or public/private/hybrid cloud storage modules having too many or too few available processing resources at the time of execution may be dedicated to storage of the migrated data prior to execution of the integration process, causing inefficiencies or failures in storage to occur upon execution. The method of FIG. 5 addresses these issues by estimating the storage and processing requirements for each integration process prior to its execution and configuring an optimal storage configuration to meet those estimated requirements.

At block 502, the hybrid integration platform in an embodiment may receive an instruction to execute a first exchange of electronic data records between an on-site customer data center and one or more public/private/hybrid cloud storage modules created and controlled by the hybrid integration platform according to a customized integration process. Data exchanges occurring pursuant to an integration process may include migration of data records between any two storage sites. For example, data records may be migrated to and/or from any of an on-site customer data center, a customer managed public cloud, a public cloud not managed by the customer, a data center of a trading partner, and/or a public/private/hybrid cloud storage module. In effect, each integration process modeled by a customer may be indifferent to the nature and location of the endpoint storage modules, removing the need for the customer to manage integration processes or storage of data migrated pursuant to integration processes. Because the method of FIG. 5 addresses issues relating to storage of data records migrated to a public/private/hybrid cloud storage module, the phrase “exchange” as used herein in relation to FIG. 5 refers to migration of data records, pursuant to an integration process, from any storage location to a public/private/hybrid cloud storage module in an embodiment.

The number, size, and type of public/private/hybrid cloud storage modules may vary, and may be more or less appropriate for a given integration process depending on, for example, the volume and type of data to be migrated pursuant to that integration process, or processing requirements associated with that integration process. As described herein, issues exist with respect to scalability of public/private/hybrid cloud storage module capacity, because the volume and type of data to be migrated and processing requirements may not be known in an embodiment prior to execution of an integration process. If the volume of data integrated is unknown, too many or too few public/private/hybrid cloud storage modules may be dedicated to storage of the migrated data, and/or public/private/hybrid cloud storage modules having too many or too few processing requirements available at the time of execution may be dedicated to the integration process prior to its execution, causing inefficiencies or failures in storage to occur upon execution.

At block 504, in an embodiment, the cloud infrastructure management system operating within the hybrid integration platform may identify a cloud infrastructure requirement associated with the first exchange. As described herein, the cloud infrastructure management system in an embodiment may reference the visual elements representing data integration processes, such as those shown in FIG. 3 to estimate the volume and/or type of data to be migrated or integrated, as well as processing requirements for the integration process prior to its execution. The cloud infrastructure management system in an embodiment may make such an estimation based on analysis of several factors associated with the integration process visual flow model generated by the customer in the visual interface, or by analysis of past migrations executed pursuant to the integration process.

In an embodiment, the cloud infrastructure management system in embodiments may estimate the volume of data records based, for example, on the number or type of branch elements, data process elements, process elements, connector elements, set properties elements, and map elements used within the model of the integration process, depth of information contained within each set properties element, and/or number of concurrent process elements that will be enacted. The cloud infrastructure management system in an embodiment may also estimate the processing resources needed to execute an integration process by analyzing the complexity of the visual model (e.g. number of data sources from which data will be accessed, number of concurrent branches will be executed, number of sub processes, and/or number of visual elements manipulating data are included). For example, the cloud infrastructure management system in an embodiment may associate an integration process modeled by a relatively less complex visual flow model display having fewer elements, fewer set properties entries, or associated with historically smaller resultant migrations with a cloud infrastructure requirement including relatively less processing power, relatively smaller storage capacity, and/or execution occurring simultaneously with other less complex integration processes associated with small data volume. As another example, the cloud infrastructure management system in another embodiment may associate an integration process modeled by a relatively more complex visual flow model display having a greater number of elements, denser set properties entries, associated with historically greater resultant migrations, or expected to occur in bursts or over long periods of time with a cloud infrastructure requirement including multiple cloud storage modules, multiple nodes, higher performing processors, and/or larger volume storage capacities. In such a way, the cloud infrastructure management system in an embodiment may estimate the volume of data to be migrated in the first exchange in order to better determine how many and which cloud storage modules/nodes to dedicate to the migration or exchange.

In another embodiment, the cloud infrastructure management system may estimate the volume and/or type of data to be migrated or integrated, processing requirements, and duration and timing of execution of an integration process prior to its execution by analyzing past migrations executed pursuant to the integration process, or estimating, based on the visual element model of the integration process whether the process will likely be executed in a continuous real-time scenario, or in a burst ETL scenario. If the integration process will be executed in a continuous real-time scenario, the hybrid integration platform may need to repeatedly access the public/private/hybrid cloud storage module and update the data stored therein based on repeated real-time executions of the same integration process. In contrast, if the integration process will be executed in a burst ETL format, the integration process will likely involve a very large migration of data to or from the public/private/hybrid cloud storage module (stored up over a period of time) and will inhibit access of the public/private/hybrid cloud storage module by any other integration processes. For example, if the cloud infrastructure management system estimates the first exchange is likely to be executed in a continuous real-time scenario, the cloud infrastructure management system in an embodiment may associate the integration process with a cloud infrastructure requirement for easy repeated access to a relatively smaller volume of data. As another example, if the cloud infrastructure management system estimates the first exchange is likely to be executed in a burst ETL scenario, the cloud infrastructure management system in another embodiment may associate the integration process with a cloud infrastructure requirement for a single, relatively long-term access to a relatively larger volume of data.

Accordingly, determination of complexity of an integration being assessed may be made by estimation of infrastructure requirements. Estimation of infrastructure requirements for an integration process may be made based upon data provided by previous integrations prepared with a customized data integration software application creation system including those crowdsourced from other users within a community of integrators or from previous integrations conducted by the user generating a presently analyzed integration having similar or the same characteristics of a present integration. Further, the several aspects of the type of or volume of data required by the number or type of branch elements, data process elements, process elements, connector elements, set properties elements, and map elements used within the model of the integration process, as well as the depth of information contained within each set properties element, and/or number of concurrent process elements similar to those that will be enacted provides for determination of the required processing, bandwidth, and storage estimated according to infrastructure resources required for those previously reported integrations having similarities to the current integration model. This may be generated as well from heuristic monitoring of infrastructure requirements for integrations including data throughput, processing requirements, and memory requirements assessed for previous integrations and reported to a integration administration system. Such integration infrastructure requirements data may be applied to estimate infrastructure requirements for an integration.

At block 506, in an embodiment, the cloud infrastructure management system may determine a cloud infrastructure configuration including one or more cloud storage modules meeting the identified one or more cloud infrastructure requirements. Each public/private/hybrid cloud storage modules may have varying characteristics, making some public/private/hybrid cloud storage modules more appropriate for certain types and volumes of integrated data than others. Upon identification of one or more cloud infrastructure requirements, the cloud infrastructure management system in an embodiment may also dynamically dedicate public/private/hybrid cloud storage modules of a size and type appropriate for the identified cloud infrastructure requirement to the first exchange. For example, in an embodiment where the cloud infrastructure management system has associated the first exchange with a cloud infrastructure requirement including a small storage capacity and/or relatively less processing power, the cloud infrastructure management system may determine the cloud infrastructure configuration should only include one public/private/hybrid cloud storage module associated with a relatively less robust processor and/or should only include public/private/hybrid cloud storage module(s) having relatively smaller storage capacities. As another example, in another embodiment where the cloud infrastructure management system has associated the first exchange with a cloud infrastructure requirement including large storage capabilities, and/or greater processing power, the cloud infrastructure management system may determine the cloud infrastructure configuration should include a public/private/hybrid cloud storage module(s) having relatively larger storage capacities and/or greater processing power. In yet another example, in an embodiment where the cloud infrastructure management system has associated the first exchange with a cloud infrastructure requirement including execution of multiple concurrent branches or sub processes within the integration process, the cloud infrastructure management system may determine the cloud infrastructure configurations should include a plurality of public/private/hybrid cloud storage modules, each associated with a separate processor capable of executing one branch of sub process of the integration process at a time. In such a way, the cloud infrastructure management system in an embodiment may dynamically scale the storage capacities dedicated to the first exchange vertically across a plurality of public/private/hybrid cloud storage modules.

At block 508, in an embodiment, the cloud infrastructure management system may configure one or more public/private/hybrid cloud storage modules according to the determined cloud infrastructure configuration. For example, in an embodiment where the cloud infrastructure management system has determined the cloud infrastructure configuration should only include one public/private/hybrid cloud storage module or node and/or should only include public/private/hybrid cloud storage module(s) or node having relatively smaller storage capacities, the cloud infrastructure management system may configure only one public/private/hybrid cloud storage module node with a relatively small storage capacity and/or lesser processing power for receipt of the incoming data migrated pursuant to the first exchange. As another example, in another embodiment where the cloud infrastructure management system has determined the cloud infrastructure configuration should include a public/private/hybrid cloud storage module(s) having relatively larger storage capacities and/or greater processing power, the cloud infrastructure management system may configure only one public/private/hybrid cloud storage module node with a relatively large storage capacity and/or greater processing power for receipt of the incoming data migrated pursuant to the first exchange. As yet another example, in another embodiment where the cloud infrastructure management system has determined the cloud infrastructure configuration should include a plurality of public/private/hybrid cloud storage modules, the cloud infrastructure management system may configure a plurality of public/private/hybrid cloud storage modules, each of which having a separate dedicated processor for receipt of the incoming data migrated pursuant to the first exchange.

At block 510, in an embodiment, the cloud infrastructure management system may determine a public/private/hybrid cloud storage module node configuration including one or more storage nodes meeting the identified one or more cloud infrastructure requirements. As described herein, a public/private/hybrid cloud storage module in an embodiment may or may not include a plurality of nodes. In an embodiment, each node within a public/private/hybrid cloud storage module may be associated with a different storage capacity. In another aspect of an embodiment, each node may also be associated with a separate processor. In yet another aspect of an embodiment, each node may be accessed by only one integration process at a time.

The cloud infrastructure management system in an embodiment may determine the public/private/hybrid cloud storage module node configuration based on, for example, an estimation of the size and type or data to be migrated during the first exchange, and/or processing requirements expected for the first exchange. For example, in an embodiment where the cloud infrastructure management system has associated the first exchange with a cloud infrastructure requirement involving relatively less processing power, relatively smaller storage capacity, and/or execution occurring simultaneously with other less complex integration processes associated with small data volume, the cloud infrastructure management system may determine the public/private/hybrid cloud storage module node configuration should include a plurality of node(s), each having relatively smaller storage capacities, and each associated with a separate processor so as to allow for simultaneous execution of multiple, less complex integration processes associated with small data volumes. As another example, in an embodiment where the cloud infrastructure management system has associated the first exchange with a cloud infrastructure requirement involving relatively less processing power, and/or relatively smaller storage capacity, but does not anticipate execution simultaneously with other integration processes, the cloud infrastructure management system may determine the public/private/hybrid cloud storage module node configuration should include only one node having relatively smaller storage capacity, and associated with a single processor likely to be capable of accommodating multiple integration processes executing consecutively, rather than simultaneously.

As another example, in another embodiment where the cloud infrastructure management system has associated the first exchange with a cloud infrastructure requirement including large storage capabilities, and/or greater processing power, the cloud infrastructure management system may determine the cloud infrastructure configuration should include a plurality of nodes, each having relatively larger storage capacities. In yet another example, in an embodiment where the cloud infrastructure management system has associated the first exchange with a cloud infrastructure requirement including execution of multiple concurrent branches or sub processes within the integration process, the cloud infrastructure management system may determine the cloud infrastructure configurations should include a plurality of nodes, each associated with a separate processor capable of executing one branch of sub process of the integration process at a time.

The cloud infrastructure management system in other embodiments may determine the public/private/hybrid cloud storage module node configuration based on, for example, an estimate of whether the process will likely be executed in a continuous real-time scenario, or in a burst ETL scenario. For example, if the cloud infrastructure management system associates the first exchange integration process with a cloud infrastructure requirement for easy repeated access to a relatively smaller volume of data in an embodiment, the cloud infrastructure management system may determine a public/private/hybrid cloud storage module node configuration including only one storage node of a relatively smaller size may be more appropriate for the first exchange. As another example, if the cloud infrastructure management system associates the first exchange integration process with a cloud infrastructure requirement for a single, relatively long-term access to a relatively larger volume of data in an embodiment, the cloud infrastructure management system may determine a public/private/hybrid cloud storage module node configuration including a plurality of storage nodes, each of a relatively larger size may be more appropriate for the first exchange. In such an embodiment, the cloud infrastructure management system may further determine the storage nodes within the configuration should not also store data already migrated or expected to be migrated in a later exchange pursuant to an integration process that is estimated to be executed on a repeated, continuous, real-time basis. In such a way, the cloud infrastructure management system in an embodiment may optimize throughput by ensuring two processes (e.g. one executed in a burst ETL scenario over a long period of time and another executed repeatedly in a continuous real-time scenario over a relatively shorter period of time) do not attempt to simultaneously access the same node, resulting in one of the processes having to wait until the other is complete.

At block 512, in an embodiment, the cloud infrastructure management system may generate the determined public/private/hybrid cloud storage module node configuration within one of the public/private/hybrid cloud storage modules. For example, in an embodiment where the cloud infrastructure management system has determined the public/private/hybrid cloud storage module node configuration should only include one storage node within a public/private/hybrid cloud storage module and/or should only include storage node(s) having relatively smaller storage capacities, the public/private/hybrid cloud storage module may generate only one storage node with a relatively small storage capacity within the public/private/hybrid cloud storage module for receipt of the incoming data migrated pursuant to the first exchange. As another example, in another embodiment where the cloud infrastructure management system has determined the public/private/hybrid cloud storage module node configuration should include a plurality of nodes within a plurality of public/private/hybrid cloud storage modules and/or should include storage nodes having relatively larger storage capacities, the public/private/hybrid cloud storage module may generate a plurality of storage nodes within a plurality of public/private/hybrid cloud storage modules, at least one of which have relatively larger storage capacity for receipt of the incoming data migrated pursuant to the first exchange.

The generation of the determined public/private/hybrid cloud storage module node configuration in an embodiment may be accomplished by generating an elastic file system within the public/private/hybrid cloud storage module. As described herein, the elastic file system in an embodiment may track the node location of each migrated data record within the public/private/hybrid cloud storage module, and may adaptively control the storage capacity of each node by automatically scaling the storage capacity up or down as a data record is migrated in or out of the node. By generating an electric file system, or updating an existing file system including the determined node configuration, the cloud infrastructure management system in an embodiment may effectively instruct the elastic file system to ready one or more nodes for storage of the migrated data.

At block 514, in an embodiment, the cloud infrastructure management system may store each of the first exchanged electronic data records within one of the public/private/hybrid cloud storage modules according to the determined cloud infrastructure configuration. For example, in an embodiment where the cloud infrastructure management system has configured only one public/private/hybrid cloud storage module with a relatively small storage capacity for receipt of the incoming data migrated pursuant to the first exchange, the cloud infrastructure management system may store each of the first exchanged electronic data records within the single public/private/hybrid cloud storage module having relatively small storage capacity configured for the first exchange. As another example, in another embodiment where the cloud infrastructure management system has configured a plurality of public/private/hybrid cloud storage modules, at least one of which have relatively larger storage capacity for receipt of the incoming data migrated pursuant to the first exchange, the cloud infrastructure management system may store each of the first exchanged electronic data records within one of the plurality of public/private/hybrid cloud storage module having relatively larger storage capacity configured for the first exchange.

At block 516, in an embodiment, the cloud infrastructure management system may store each of the first exchanged electronic data records within one of the storage nodes and update the elastic file system describing the public/private/hybrid cloud storage module node configuration and records stored within each storage node. For example, in an embodiment where the public/private/hybrid cloud storage module generates only one storage node with a relatively small storage capacity within the public/private/hybrid cloud storage module for receipt of the incoming data migrated pursuant to the first exchange, each of the first exchanged electronic data records may be stored within the single storage node with a relatively small storage capacity which the public cloud management system directed the elastic file system to create. In such an embodiment, the elastic file system may then record storage of each of the first exchanged electronic data records with the single storage node created for storage of data migrated in the first exchange. As another example, in another embodiment where the public/private/hybrid cloud storage module generates a plurality of storage nodes within a plurality of public/private/hybrid cloud storage modules, at least one of which have relatively larger storage capacity for receipt of the incoming data migrated pursuant to the first exchange, each of the first exchanged electronic data records may be stored within one of a plurality of storage nodes with relatively larger storage capacities which the public cloud management system directed the elastic file system to create. In such an embodiment, the elastic file system may then record each of the first exchanged electronic data records as having been stored within whichever of the one of the plurality of nodes created for storage of data migrated in the first exchange within which each data record is stored.

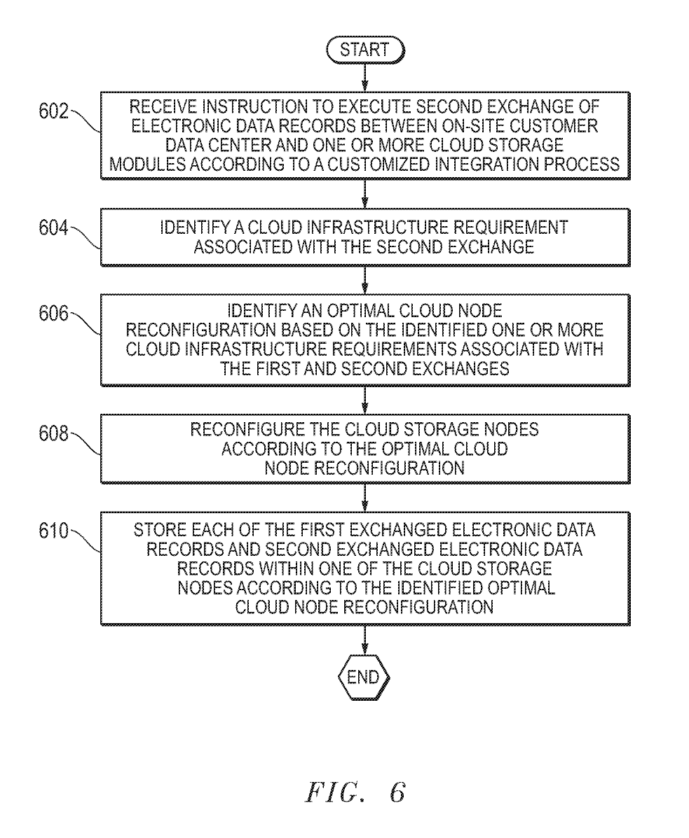

FIG. 6 is a flow diagram illustrating a method of reconfiguring storage of electronic data records within a public/private/hybrid cloud storage module exchanged in a plurality of customized integration processes according to an embodiment of the present disclosure. As described herein, the cloud infrastructure management system in embodiments of the present disclosure may provide for adaptive movement of data records within the public/private/hybrid cloud storage modules by operably connecting each node within a public/private/hybrid cloud storage module to an elastic load balancer that may relocate data records between nodes in response to estimated throughput demands.

FIG. 6 in an embodiment may address issues associated with not knowing the size and type of data to be migrated in each integration process, or the timing of future integration processes. As described herein, in previous systems, it may have been known, prior to execution of each integration process, which integration processes would run simultaneously. In contrast, timing of executions of integration processes may not be known prior to execution of the integration process. This lack of knowledge prior to execution of each integration process may present issues relating to throughput for each integration process, or the ability of each integration process to quickly and effectively access stored migrated data or data storage locations set aside for data to be migrated pursuant to a given integration process.

Each node of a public/private/hybrid cloud storage module may be simultaneously accessed by separate integration processes, and in some embodiments a single node may be accessed by one process at a time. In such embodiments, if two separate integration processes need to access the same node in order to complete an associated data migration, one of those integration processes must wait until the other integration process has completed, instead of running both integration processes simultaneously. The method of FIG. 6 addresses such issues by adaptively responding to multiple integration processes attempting to access the same node within a public/private/hybrid cloud storage module and by shifting the location of the portion of data the second integration process is attempting to access to a separate node, in order to allow both processes to execute simultaneously. In such a way the cloud infrastructure management system in embodiments of the present disclosure may address issues relating to ability to adaptively move the data records within the public/private/hybrid cloud storage modules in response to high demands in throughput caused by burst ETL migrations, or other causes during integration activity.

At block 602, in an embodiment, the cloud infrastructure management system may receive an instruction to execute a second exchange of electronic data records between an on-site customer data center and one or more public/private/hybrid cloud storage modules according to a customized integration process. Data exchanges occurring pursuant to an integration process may include migration of data records between any two storage sites. For example, data records may be migrated to and/or from any of an on-site customer data center, a customer managed public cloud, a public cloud not managed by the customer, a data center of a trading partner, and/or a public/private/hybrid cloud storage module. In effect, each integration process modeled by a customer may be indifferent to the nature and location of the endpoint storage modules, removing the need for the customer to manage integration processes or storage of data migrated pursuant to integration processes. In at least one embodiment, the exchange of block 602 may include migration of data records, pursuant to an integration process, from any storage location to a public/private/hybrid cloud storage module.

The first exchange described herein may occur at an earlier time than the second exchange, or may occur simultaneously with this second exchange of electronic data records, potentially decreasing the throughput associated with each integration process. Although FIG. 6 describes a second exchange between the public/private/hybrid cloud storage module and an on-site customer data center, other embodiments may include, but may not be limited to exchanges between the public/private/hybrid cloud storage module and public cloud storage modules, client controlled public loud storage modules, trading partner data centers, and/or the service provider server/system.

At block 604, in an embodiment the cloud infrastructure management system may identify a cloud infrastructure requirement associated with the second exchange. Similar to the first exchange described herein, the cloud infrastructure management system in an embodiment may reference the visual elements representing the data integration process of the second exchange, such as those shown in FIG. 3 to estimate the volume and/or type of data to be migrated or integrated prior to execution of the integration process.

At block 604, in an embodiment, the cloud infrastructure management system may identify a cloud infrastructure requirement associated with the second exchange. Similar to the first exchange described herein, the cloud infrastructure management system in an embodiment may reference the visual elements representing data integration processes, such as those shown in FIG. 3 to estimate the volume and/or type of data to be migrated or integrated, as well as processing requirements for the integration process prior to its execution. The cloud infrastructure management system in an embodiment may make such an estimation based on analysis of several factors associated with the integration process visual flow model generated by the customer in the visual interface, or by analysis of past migrations executed pursuant to the integration process.

In an embodiment, the cloud infrastructure management system may estimate the volume of data records based, for example, on the number or type of branch elements, data process elements, process elements, connector elements, set properties elements, and map elements used within the model of the integration process, depth of information contained within each set properties element, and/or number of concurrent process elements that will be enacted. The cloud infrastructure management system in an embodiment may also estimate the processing resources needed to execute an integration process by analyzing the complexity of the visual model (e.g. number of data sources from which data will be accessed, number of concurrent branches will be executed, number of sub processes, and/or number of visual elements manipulating data are included). For example, the cloud infrastructure management system in an embodiment may associate an integration process modeled by a relatively less complex visual flow model display having fewer elements, fewer set properties entries, or associated with historically smaller resultant migrations with a cloud infrastructure requirement including relatively less processing power, relatively smaller storage capacity, and/or execution occurring simultaneously with other less complex integration processes associated with small data volume. As another example, the cloud infrastructure management system in another embodiment may associate an integration process modeled by a relatively more complex visual flow model display having a greater number of elements, denser set properties entries, associated with historically greater resultant migrations, or expected to occur in bursts or over long periods of time with a cloud infrastructure requirement including multiple cloud storage modules, multiple nodes, higher performing processors, and/or larger volume storage capacities. In such a way, the cloud infrastructure management system in an embodiment may estimate the volume of data to be migrated in the first exchange in order to better determine how many and which cloud storage modules/nodes to dedicate to the migration or exchange.

In another embodiment, the cloud infrastructure management system may estimate the volume and/or type of data to be migrated or integrated, processing requirements, and duration and timing of execution of an integration process prior to its execution by analyzing past migrations executed pursuant to the integration process, or estimating, based on the visual element model of the integration process whether the process will likely be executed in a continuous real-time scenario, or in a burst ETL scenario. If the integration process will be executed in a continuous real-time scenario, the hybrid integration platform may need to repeatedly access the public/private/hybrid cloud storage module and update the data stored therein based on repeated real-time executions of the same integration process. In contrast, if the integration process will be executed in a burst ETL format, the integration process will likely involve a very large migration of data to or from the public/private/hybrid cloud storage module (stored up over a period of time) and will inhibit access of the public/private/hybrid cloud storage module by any other integration processes. For example, if the cloud infrastructure management system estimates the first exchange is likely to be executed in a continuous real-time scenario, the cloud infrastructure management system in an embodiment may associate the integration process with a cloud infrastructure requirement for easy repeated access to a relatively smaller volume of data. As another example, if the cloud infrastructure management system estimates the first exchange is likely to be executed in a burst ETL scenario, the cloud infrastructure management system in another embodiment may associate the integration process with a cloud infrastructure requirement for a single, relatively long-term access to a relatively larger volume of data.

The determination of complexity of an integration being assessed may be made by estimation of infrastructure requirements for the exchanges of data records for the integration process or processes. Estimation of infrastructure requirements for an integration process may be made according to various embodiments herein based upon data provided by previous integrations prepared with a customized data integration software application creation system including those crowdsourced from other users within a community of integrators or from previous integrations conducted by the user generating a presently analyzed integration having similar or the same characteristics of a present integration. Several aspects of the type of or volume of data required by the number or type of branch elements, data process elements, process elements, connector elements, set properties elements, and map elements used within the model of the integration process, as well as the depth of information contained within each set properties element, and/or number of concurrent process elements similar to those that will be enacted provides for determination of the required processing, bandwidth, and storage estimated from infrastructure requirements required for previously reported integrations. This may be generated as well from heuristic monitoring of infrastructure requirements for integrations including data throughput, processing requirements, and memory requirements assessed for previous integrations and reported to a integration administration system. Such integration infrastructure requirements data may be applied to estimate infrastructure requirements for an integration.

At block 606, in an embodiment, the elastic load balancer may communicate with the cloud infrastructure management system to identify an optimal public/private/hybrid cloud storage module node reconfiguration based on the identified one or more cloud infrastructure requirements associated with the first and second exchanges. As described herein, each node of a public/private/hybrid cloud storage module in an embodiment may be simultaneously accessed by a separate integration process, but a single node may be accessed by only one process at a time. The elastic load balancer in embodiments of the present disclosure may adaptively respond to multiple integration processes attempting to access the same node within a public/private/hybrid cloud storage module by shifting the location of the portion of data the second integration processes is attempting to access to a separate node, in order to allow both processes to execute simultaneously.

For example, the elastic load balancer in an embodiment may associate a cloud infrastructure requirement involving smaller storage capacities associated with a first exchange and a cloud infrastructure requirement involving relatively larger storage capacities associated with a simultaneous second exchange with an optimal public/private/hybrid cloud storage module node reconfiguration dedicating one or more larger capacity storage nodes to the second exchange and only one smaller capacity storage node with the first exchange. As another example, the elastic load balancer in an embodiment may associate a cloud infrastructure requirement involving less processing power associated with a first exchange and a cloud infrastructure requirement involving relatively greater processing power associated with a simultaneous second exchange with an optimal public/private/hybrid cloud storage module node reconfiguration dedicating one or more nodes with higher performance processors to the second exchange and only one node with a relatively lower performance process with the first exchange. As yet another example, if the first and second exchanges are not executed simultaneously, the elastic load balancer in an embodiment may associate a cloud infrastructure requirement for storage of multiple copies of the data records stored in the public/private/hybrid cloud storage module pursuant to a first exchange with an optimal public/private/hybrid cloud storage module node reconfiguration that includes multiple copies of the data records stored in the public/private/hybrid cloud storage module pursuant to the first exchange wherein each copy is stored in a separate node.

At block 608, in an embodiment the cloud infrastructure management system may reconfigure the public/private/hybrid cloud storage module nodes according to the optimal public/private/hybrid cloud storage module node reconfiguration. In an embodiment, the elastic load balancer may direct the elastic file system to reconfigure the structure or size of one or more nodes within a public/private/hybrid cloud storage module according to the optimal public/private/hybrid cloud storage module node reconfiguration. As described herein, the elastic file system in an embodiment may track the node location of each migrated data record within the public/private/hybrid cloud storage module, and may adaptively control the storage capacity of each node by automatically scaling the storage capacity up or down as a data record is migrated in or out of the node. Thus, the elastic load balancer may direct the elastic file system to increase the storage capacity of a node in anticipation of the storage of additional data records within it, to move data records currently stored in one node to another node in order to optimize throughput for anticipated simultaneous future exchanges, and/or to create new nodes to optimize throughput for anticipated simultaneous future exchanges.

For example, the elastic load balancer in an embodiment may instruct the elastic file system to reconfigure the public/private/hybrid cloud storage module nodes according to an optimal public/private/hybrid cloud storage module node reconfiguration dedicating one or more larger capacity storage nodes or one or more storage nodes with higher performing processors to the second exchange and only one smaller capacity storage node or only one node with a relatively lower performing processor with the first exchange. As another example, if the first and second exchanges are not executed simultaneously, the elastic load balancer in an embodiment may instruct the elastic file system to reconfigure the public/private/hybrid cloud storage module nodes according to an optimal public/private/hybrid cloud storage module node reconfiguration that includes multiple copies of the data records stored in the public/private/hybrid cloud storage module pursuant to the first exchange wherein each copy is stored in a separate node.

At block 610, in an embodiment, the cloud infrastructure management system may store each of the first exchanged electronic data records and second exchanged electronic data records within one of the public/private/hybrid cloud storage module nodes according to the identified optimal public/private/hybrid cloud storage module node reconfiguration. For example, in an embodiment where the elastic file system has reconfigured the public/private/hybrid cloud storage module nodes according to an optimal public/private/hybrid cloud storage module node reconfiguration dedicating one or more larger capacity storage nodes or one or more storage nodes having a higher performance processor to the second exchange and only one smaller capacity storage node or only one node having a relatively lower performing processor with the first exchange, the cloud infrastructure management system may store the data migrated during the second exchange to the one or more larger capacity storage nodes and the data migrated during the first exchange to the single smaller capacity storage node. As another example, in an embodiment in which the elastic file system has reconfigured the public/private/hybrid cloud storage module nodes according to an optimal public/private/hybrid cloud storage module node reconfiguration that includes multiple copies of the data records stored in the public/private/hybrid cloud storage module pursuant to the first exchange wherein each copy is stored in a separate node, the public/private/hybrid cloud storage module may store each of the data records migrated during the second exchange to only one of the nodes containing copies of the data records migrated during the first exchange. In such a way the cloud infrastructure management system, in communication with the elastic load balancer in an embodiment may address issues relating to ability to adaptively move the data records within the public/private/hybrid cloud storage modules in response to high demands in throughput caused by burst ETL migrations or other simultaneously executing integration processes.

For example, in an embodiment where the cloud infrastructure management system has configured only one public/private/hybrid cloud storage module with a relatively small storage capacity for receipt of the incoming data migrated pursuant to the first exchange, the cloud infrastructure management system may store each of the first exchanged electronic data records within the single public/private/hybrid cloud storage module having relatively small storage capacity configured for the first exchange. As another example, in another embodiment where the cloud infrastructure management system has configured a plurality of public/private/hybrid cloud storage modules, at least one of which have relatively larger storage capacity for receipt of the incoming data migrated pursuant to the first exchange, the cloud infrastructure management system may store each of the first exchanged electronic data records within one of the plurality of public/private/hybrid cloud storage module having relatively larger storage capacity configured for the first exchange.

The blocks of the flow diagrams discussed above need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram. Further, those of skill will understand that additional blocks or steps, or alternative blocks or steps may occur within the flow diagrams discussed for the algorithms above.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system operating a cloud infrastructure management system comprising:
a memory comprising a cloud storage module, wherein the cloud storage module is a networked server, providing storage capacity for storage of electronic data records;
a processor executing machine readable executable code instructions of an established customized software integration application to perform a first exchange of electronic data records from an on-site customer data center to the cloud storage module according to a specific integration process generated from a customized visual model with a plurality of visual modeling elements selected from a menu of visual modeling elements, each visual modeling element including:
a connector code set comprising data required for electronic communication in accordance with a specific application programming interface (API); or
a trading partner code set comprising data required for electronic communication with a specific trading partner's system;
the processor executing machine readable executable code instructions of the cloud infrastructure management system to:
identify one or more cloud infrastructure requirements associated with the first exchange;
for the cloud storage module, determine a cloud infrastructure configuration including the cloud storage module meeting the identified one or more cloud infrastructure requirements; and
store each of the first exchanged electronic data records within the cloud storage module according to the determined cloud infrastructure configuration.

2. The information handling system of claim 1, wherein the cloud storage module includes one or more storage nodes for providing adjustable storage resources for meeting the identified one or more cloud infrastructure requirements, and an elastic file system describing the cloud storage module node configuration.

3. The information handling system of claim 1 further comprising:
the processor performing a second exchange of electronic data records between the on-site customer data center and the cloud storage module, wherein the second exchange includes an exchange of the electronic data records between the on-site customer data center and the cloud storage module;
the processor identifying one or more cloud infrastructure requirements associated with the second exchange; and
the processor identifying an optimal cloud storage module node reconfiguration of the first and second exchanged electronic data records based on the identified one or more cloud infrastructure requirements associated with the first and second exchanges.

4. The information handling system of claim 3, wherein the processor stores each of the first exchanged electronic data records and the second exchanged electronic data records within one of the storage nodes according to the optimal cloud storage module node reconfiguration.

5. The information handling system of claim 2, wherein the cloud storage module node configuration describes the number of private cloud storage nodes, storage capabilities of each private cloud storage node, and processing capabilities of each private cloud storage node.

6. The information handling system of claim 1, wherein the one or more cloud infrastructure requirements are determined based on the number or type of visual modeling elements included within the specific integration process to achieve the first exchange.

7. The information handling system of claim 1, wherein each of the configured one or more cloud storage modules stores a first set of electronic data records belonging to a first customer and a second set of electronic data records belonging to a second customer.

8. A method of managing hybrid integration with a private cloud comprising:
performing, via a processor executing code instructions, a first exchange of electronic data records from a first on-site customer data center to one or more cloud storage modules according to a specific integration process generated from a customized visual model with a plurality of visual modeling elements selected from a menu of visual modeling elements, each visual modeling element including:
a connector code set comprising data required for electronic communication in accordance with a specific application programming interface (API); or
a trading partner code set comprising data required for electronic communication with a specific trading partner's system;
identifying one or more cloud infrastructure requirements associated with the first exchange;
determining a cloud infrastructure configuration including one or more cloud storage modules meeting the identified one or more cloud infrastructure requirements;
configuring one or more cloud storage modules according to the determined cloud infrastructure configuration; and
storing, via a plurality of memory resources, each of the first exchanged electronic data records within one of the cloud storage modules according to the determined cloud infrastructure configuration.

9. The method of claim 8, wherein the cloud storage module includes one or more storage nodes for providing adjustable storage resources for meeting the identified one or more cloud infrastructure requirements, and an elastic file system describing the cloud storage module node configuration.

10. The method of claim 8 further comprising:
performing a second exchange of electronic data records between the on-site customer data center and the cloud storage module, wherein the second exchange includes an exchange of the electronic data records between the on-site customer data center to the cloud storage module;
identifying one or more cloud infrastructure requirements associated with the second exchange; and
identifying an optimal cloud storage module node reconfiguration of the first and second exchanged electronic data records based on the identified one or more cloud infrastructure requirements associated with the first and second exchanges.

11. The method of claim 10 further comprising:
storing each of the first exchanged electronic data records and the second exchanged electronic data records within one of the storage nodes according to the optimal cloud storage module node reconfiguration.

12. The method of claim 9, wherein the cloud storage module node configuration describes the number of copies of data records stored pursuant to the first exchange are stored in the cloud storage module.

13. The method of claim 8, wherein the one or more cloud infrastructure requirements are determined based on the number branch elements or sub process elements included within the specific integration process to achieve the first exchange.

14. The method of claim 11, wherein performance of the first exchange of electronic data records occurs simultaneously with performance of the second exchange of electronic data records.

15. An information handling system operating a cloud infrastructure management system comprising:
a memory comprising a cloud storage module, wherein the cloud storage module is a plurality of networked servers, each providing storage capacity for storage of electronic data records;
a processor executing machine readable executable code instructions of an established customized software integration application to perform a first exchange of electronic data records from cloud-based customer data center to the cloud storage module according to a specific integration process generated from a customized visual model with a plurality of visual modeling elements selected from a menu of visual modeling elements, each visual modeling element including:
a connector code set comprising data required for electronic communication in accordance with a specific application programming interface (API); or
a trading partner code set comprising data required for electronic communication with a specific trading partner's system;
the processor executing machine readable executable code instructions of the cloud infrastructure management system to:
identify one or more cloud infrastructure requirements associated with the first exchange based on the number or type of visual modeling elements included within the specific integration process;
determine a cloud infrastructure configuration including the cloud storage module meeting the identified one or more cloud infrastructure requirements; and
store each of the first exchanged electronic data records within the cloud storage module according to the determined cloud infrastructure configuration.

16. The information handling system of claim 15, wherein the cloud storage module includes one or more storage nodes for providing adjustable storage resources for meeting the identified one or more cloud infrastructure requirements, and an elastic file system describing a cloud storage module node configuration, and wherein each of the one or more nodes is one of the plurality of networked servers.

17. The information handling system of claim 15 further comprising:
the processor performing a second exchange of electronic data records between the cloud-based customer data center and the cloud storage module, wherein the second exchange includes either an exchange of the electronic data records between the cloud-based customer data center and the cloud storage module;
the processor identifying one or more cloud infrastructure requirements associated with the second exchange; and
the processor identifying an optimal cloud storage module node reconfiguration of the first and second exchanged electronic data records based on the identified one or more cloud infrastructure requirements associated with the first and second exchanges.

18. The information handling system of claim 17, wherein the processor stores each of the first exchanged electronic data records and the second exchanged electronic data records within one of the storage nodes according to the optimal cloud storage module node reconfiguration.

19. The information handling system of claim 16, wherein the cloud storage module node configuration determines the number of private cloud storage nodes, storage capabilities, and processing capabilities of each private cloud storage node.

20. The information handling system of claim 18, wherein performance of the first exchange of electronic data records partially overlaps in time with performance of the second exchange of electronic data records.
